(19) United States
(12) Patent Application Publication
(10) Pub. No.: US 2017/0107132 A1
(43) Pub. Date: Apr. 20, 2017

(54) RECYCLING TREATMENT SYSTEM FOR TANNERY WASTEWATER

(71) Applicant: New Century Membrane Technology Co., Ltd., Taichung City (TW)

(72) Inventor: CHI-CHANG KUO, Taichung City (TW)

(21) Appl. No.: 14/883,541

(22) Filed: Oct. 14, 2015

(51) Int. Cl. C02F 9/00; C02F 1/44; C02F 1/52; B01D 15/36; C02F 3/12; B01D 61/58; B01D 61/02; B01D 61/14; C02F 1/42; C02F 1/04

(52) U.S. Cl. CPC C02F 9/00; C02F 1/42; C02F 1/444; C02F 1/441; C02F 1/52; C02F 1/048; C02F 3/1221; B01D 61/58; B01D 61/025; B01D 61/145; B01D 15/362; C02F 2001/425; C02F 2001/5218; C02F 2103/24

(57) ABSTRACT

A recycling treatment system for tannery wastewater is fixed between a sequencing batch reactor (SBR) and filter press equipment, and the recycling treatment system contains: a first ultrafiltration unit, a second ultrafiltration unit, a cation exchange unit, an osmosis processing unit, a recycling tank, a RO concentration tank, and an evaporation unit. The first ultrafiltration unit includes a filtering tank, a plurality of ultrafiltration sets with plural first ultrafiltration bags and a fluid tube. The second ultrafiltration unit includes a concentration tank, at least one rotary ultrafiltration assembly, a backwash pipe, and a discharge pipe. The cation exchange unit includes a reaction sink and cationic resin. The osmosis processing unit includes plural first reverse osmosis sets and plural second reverse osmosis sets. The RO concentration tank is mounted beside the osmosis processing unit, and the evaporation unit is configured between the RO concentration tank and the recycling tank.

### FIELD OF THE INVENTION

The present invention relates to a water treatment system, and more particularly to a recycling treatment system for tannery wastewater which reduces waste waters and save operation cost.

### BACKGROUND OF THE INVENTION

Leather products are made of raw hides and skins in tanneries and produces wastewaters with chloride, sulfide, heavy metals, suspended solids and chromium salts to interfere COD test and to cause pollution to biological treatment system.

A conventional wastewater treatment is applied to activate sludge and to enhance stability of water quality, but a concentration of supply water is not high, sulfide and chromium in the wastewater restrain biochemical reaction, and such a wastewater treatment requires high power consumption and land cost.

Sequencing batch reactor (SBR) improves above-mentioned defects and contains activated sludge cultivated in a reaction tank, wastewater guided therein, and aeration is processed. When the wastewater flows into the reaction tank to mix with the activated sludge, oxygen generates so that microorganism in the sludge causes metabolism of organics substances in the wastewater, thus degrading ammonia and organic substances and increasing microbial cells. Thereafter, a deposition is processed in the SBR to separate the microbial cells apart from the wastewater, and clean fluids are eliminated so that the sludge maintains in the reaction tank and mixes with the wastewater, thus treating the wastewater.

The SBR does not have a first-time deposition tank, a second-time deposition tank and sludge return equipment so as to reduce treatment cost, yet it generates impurities and the sludge in the reaction tank easily to decrease COD value. Although moisture of the sludge in the reaction tank is lowered, more organics substances and a density of suspended solids (SS) exist in the wastewater to have environment pollution.

To solve such a problem, membrane filtration system is configured to separate solid substances and fluids in the wastewater of the SBR, however, concentration polarization generates on the filtration membrane easily to lower liquidity of filtered fluids and service life of the filtration membrane.

The present invention has arisen to mitigate and/or obviate the afore-described disadvantages.

### SUMMARY OF THE INVENTION

The primary objective of the present invention is to provide a recycling treatment system for tannery wastewater which contains the first ultrafiltration unit and the second ultrafiltration unit configured to filter the waste waters, and the cation exchange unit eliminates minerals and the heavy metals to avoid a clog in the holes on a distal end of the reverse osmosis treatment system. Preferably, the first ultrafiltration unit and the second ultrafiltration unit backwash and scratch the sludge on the plural first and second ultrafiltration bags so as to maintain filtration of the plurality of ultrafiltration sets and the at least one rotary ultrafiltration assembly after a period of using time.

Secondary objective of the present invention is to provide a recycling treatment system for tannery wastewater in which the plurality of ultrafiltration sets, the at least one rotary ultrafiltration assembly, and the reverse osmosis treatment reduce the moisture content of the sludge to enhance recycling rate of the waste waters and to lower energy consumption in evaporation and crystallization of the sludge, thus decreasing waste waters and treatment cost.

Further objective of the present invention is to provide a recycling treatment system for tannery wastewater in which COD value and TDS value of the recycled water produced by treatment system of SBR are controlled less than 30 mg/L and 150 mg/L so as to comply with environmental standard and to acquire excellent water quality, and the recycling rate of the waste waters is over 90% to overcome instability of the water quality produced by the conventional SBR.

Another objective of the present invention is to provide a recycling treatment system for tannery wastewater in which the filtered fluids stored in the recycling tank are evaporated, crystalized, and guided back to the SBR, and the solid residue is recycled and treated by the filter press equipment, thus reducing discharge of the waste waters greatly.

To obtain the above objectives, a recycling treatment system for tannery wastewater provided by the present invention contains: a first ultrafiltration unit, a second ultrafiltration unit, a cation exchange unit, an osmosis processing unit, a recycling tank, a RO concentration tank, and an evaporation unit.

The first ultrafiltration unit includes a filtering tank configured to store concentrated sludge from the sequencing batch reactor, and the first ultrafiltration unit also includes a plurality of ultrafiltration sets, each ultrafiltration set deposits in the filtering tank and is formed in a circular disc shape, said each ultrafiltration set has plural first ultrafiltration bags arranged therein, and said each ultrafiltration set also has a fluid tube configured to pump filtered fluids out of the filtering tank from the plural first ultrafiltration bags.

The second ultrafiltration unit includes a concentration tank configured to store the sludge stopped by the first ultrafiltration unit, and the second ultrafiltration unit also includes at least one rotary ultrafiltration assembly formed in a circular disk shape and rotating in the concentration tank by using a power source. The second ultrafiltration unit further includes a backwash pipe configured to collect the filtered fluids flowing through the at least one rotary ultrafiltration assembly, and the backwash pipe is in connection with the concentration tank, the second ultrafiltration unit further includes a discharge pipe mounted on a bottom of the concentration tank and communicating with the filter press equipment.

The cation exchange unit is connected with one end of the fluid tube and includes a reaction sink and cationic resin filled in the reaction sink.

The osmosis processing unit is mounted beside the cation exchange unit and includes plural first reverse osmosis sets and plural second reverse osmosis sets, wherein the filtered fluids are pumped by a plurality of pressure pumps and are filtered by the plural first reverse osmosis sets and the plural second reverse osmosis sets, thus recycling the filtered fluids.

The recycling tank is configured to recycle recycled water.

The RO concentration tank is mounted beside the osmosis processing unit and is configured to accommodate waste waters stopped by said each first reverse osmosis set and said each second reverse osmosis set.

The evaporation unit is configured between the RO concentration tank and the recycling tank so as to guide the sludge on a bottom of the RO concentration tank and to treat the sludge after condensate purification, such that volatilized substances are removed and distilled waters produce, and the distilled waters are guided into the recycling tank for recycling and reusing purpose.

### BRIEF DESCRIPTION OF THE DRAWINGS

FIG. 1 is a flowchart of a recycling treatment system for tannery wastewater according to a preferred embodiment of the present invention.

FIG. 2 is a diagram showing the assembly of the recycling treatment system for tannery wastewater according to the preferred embodiment of the present invention.

FIG. 3 is a cross sectional view showing the assembly of a first ultrafiltration unit of the recycling treatment system for tannery wastewater according to the preferred embodiment of the present invention.

FIG. 4 is a plane view showing the assembly of a scratching module and at least one rotary ultrafiltration assembly of a second ultrafiltration unit of the recycling treatment system for tannery wastewater according to the preferred embodiment of the present invention.

### DETAILED DESCRIPTION OF THE PREFERRED EMBODIMENTS

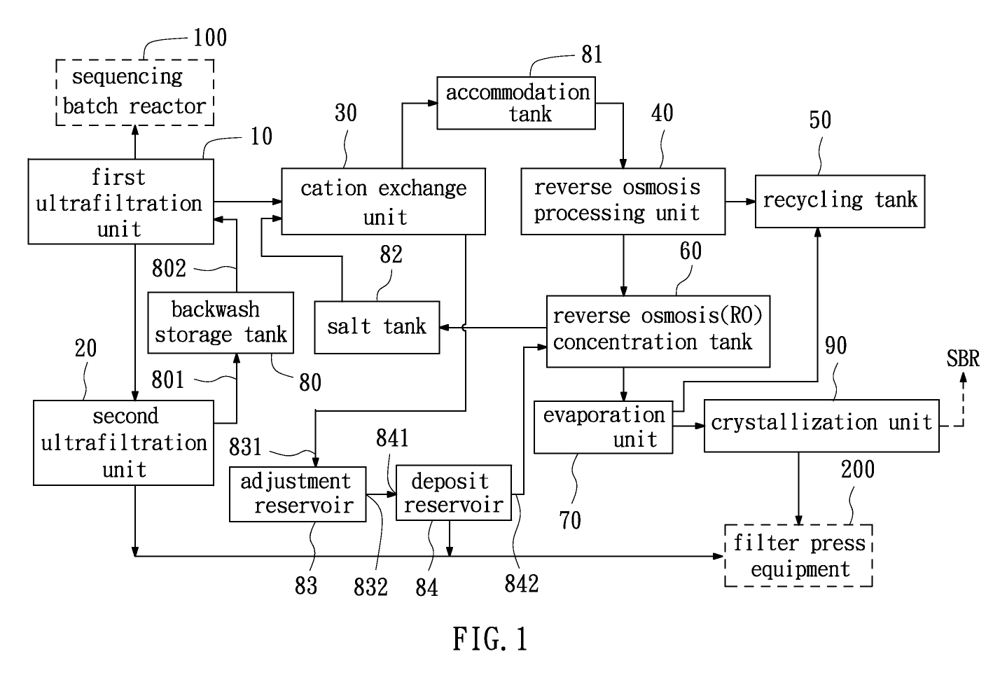

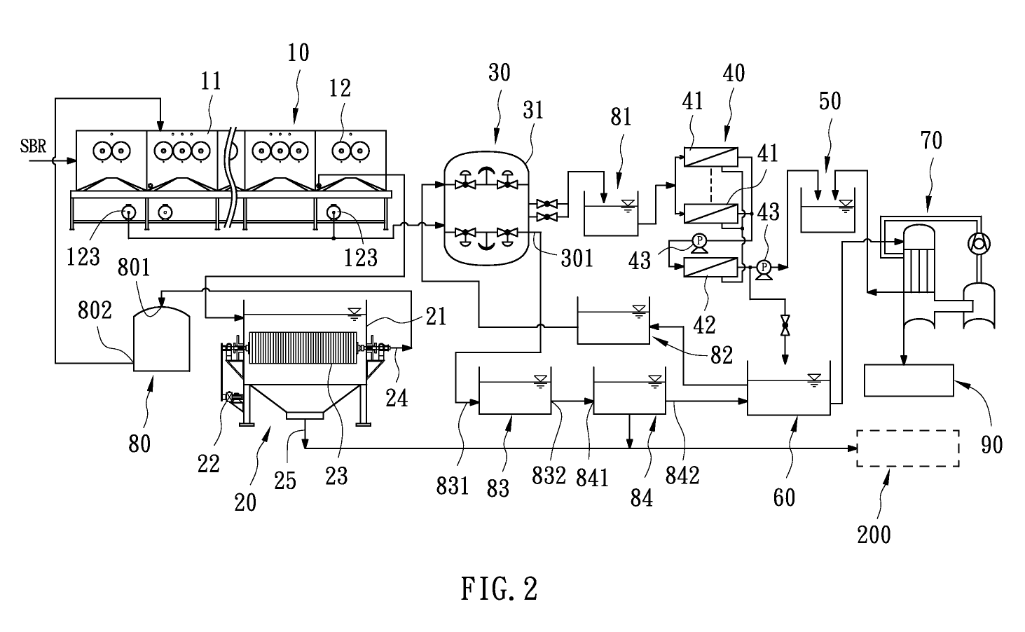

With reference to FIGS. 1 and 2, a recycling treatment system for tannery wastewater according to a preferred embodiment of the present invention is fixed between a sequencing batch reactor 100 (SBR) and filter press equipment 200, and the recycling treatment system comprises a first ultrafiltration unit 10, a second ultrafiltration unit 20, a cation exchange unit 30, a reverse osmosis processing unit 40, a recycling tank 50, a reverse osmosis (RO) concentration tank 60, an evaporation unit 70, a backwash storage tank 80, and a crystallization unit 90.

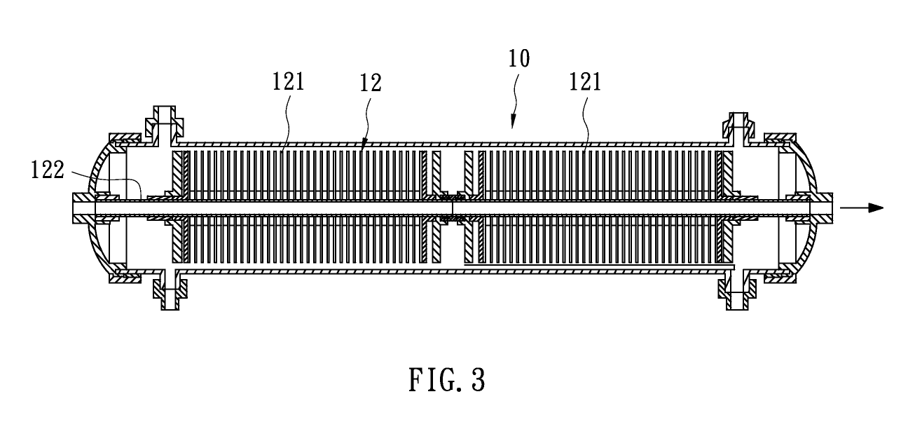

Referring to FIG. 3, the first ultrafiltration unit 10 includes a filtering tank 11 configured to store concentrated sludge from the sequencing batch reactor 100 (SBR), and the first ultrafiltration unit 10 also includes a plurality of ultrafiltration sets 12, each ultrafiltration set 12 deposits in the filtering tank 11 and is in a circular disc shape, said each ultrafiltration set 12 has plural first ultrafiltration bags 121 arranged therein and has a fluid tube 122 configured to pump filtered fluids out of the filtering tank 11 from the plural first ultrafiltration bags 121. In this embodiment, each first ultrafiltration bag 121 is hollow and is made of polyvinylidene fluoride (PVFD), said each first ultrafiltration bag 121 has two films which are attached on two sides of a mesh layer, and each film has plural pores each with a diameter of 0.1 to 0.01 μm.

The second ultrafiltration unit 20 includes a concentration tank 21 configured to store the sludge stopped by the first ultrafiltration unit 10, and the second ultrafiltration unit 20 also includes at least one rotary ultrafiltration assembly 23 formed in a circular disk shape and rotating in the concentration tank 21 by using a power source 22. The second ultrafiltration unit 20 further includes a backwash pipe 24 configured to collect the filtered fluids flowing through the at least one rotary ultrafiltration assembly 23, and the backwash pipe 24 is in connection with the concentration tank 21. The second ultrafiltration unit 20 further includes a discharge pipe 25 mounted on a bottom of the concentration tank 21 and communicating with the filter press equipment 200. The at least one rotary ultrafiltration assembly 23 has plural second ultrafiltration bags which are the same as the plural first ultrafiltration bags 121. The filtered fluids collected by the backwash pipe 24 are used as backwashing waters to the first ultrafiltration unit 10.

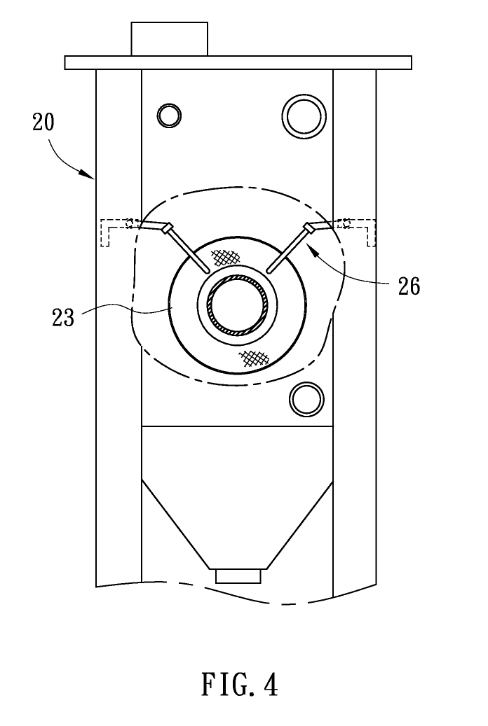

As shown in FIG. 4, the second ultrafiltration unit 20 further includes a scratching module 26 contacting with one side of the at least one rotary ultrafiltration assembly 23, wherein when the power source 22 drives the at least one rotary ultrafiltration assembly 23 to rotate in the concentration tank 21, the scratching module 26 contacts with said one side of the at least one rotary ultrafiltration assembly 23 to rotatably scratch the sludge in the concentration tank 21, thus avoiding the sludge blocking in the concentration tank 21 and prolonging service life of the least one rotary ultrafiltration assembly 23. After the filtered fluids in the concentration tank 21 are pumped to the backwash pipe 24, a density of suspended solids is increased (i.e., moisture content of the sludge decreases) to treat the sludge in the filter press equipment 200.

The backwash tank 80 is fixed between the first ultrafiltration unit 10 and the second ultrafiltration unit 20 and is configured to store the backwashing waters (i.e., the filtered fluids) from the backwash pipe 24, wherein the backwashing waters are pumped into an inlet 801 of the backwash storage tank 80 from the backwash pipe 24, and an outlet 802 of the backwash storage tank 80 is coupled with the filtering tank 11 of the ultrafiltration unit 20, such that the backwashing waters backwash the plurality of ultrafiltration sets 12 of the first ultrafiltration unit 10 so as to prolong service life of the plural first ultrafiltration bags 121.

The cation exchange unit 30 includes a reaction sink 31 and cationic resin (not shown) filled in the reaction sink 31 so as to eliminate minerals and heavy metal substances in the reaction sink 31. The cation exchange unit 30 is connected with one end of the fluid tube 122 so as to pump the filtered fluids to the reaction sink 31 through a plurality of fluid pumps 123, and the filtered fluids are cation exchanged via the cationic resin (not shown) so as to eliminate the heavy metal substances, such as chromium or barium, thus avoiding a clog in holes on a distal end of a reverse osmosis treatment system. Furthermore, an accommodation tank 81 is disposed beside the cation exchange unit 30 and between the cation exchange unit 30 and the reverse osmosis processing unit 40 to accommodate the filtered fluids which are cation exchanged.

The osmosis processing unit 40 is mounted beside the cation exchange unit 30 and includes plural first reverse osmosis sets 41 and plural second reverse osmosis sets 42, wherein the filtered fluids are pumped by a plurality of pressure pumps 43 and are filtered by the plural first reverse osmosis sets 41 and the plural second reverse osmosis sets 42, thus recycling the filtered fluids. Preferably, the osmosis processing unit 40 filters the filtered fluids in a multi-step pressurizing manner. Each first reverse osmosis set 41 has a filtration film, and each second reverse osmosis set 42 has a high-pressure resistant and desalination filtration film so as to filter the filtered fluids, thus recycling the filtered fluids. Thereafter, the filtered fluids are collected into the recycling tank 50 for recycling and reusing purpose.

A salt tank 82 is fixed beside the osmosis processing unit 40 and between the cation exchange unit 30 and the RO concentration tank 60, wherein clean fluids in an upper end of the RO concentration tank 60 are guided, and waste waters are reproduced by using salt solution to backwash the cationic resin, and after the cationic resin absorbs impurities completely, the impurities are treated by using salt solution to recover original property.

The recycling treatment system of the present invention further comprises an adjustment reservoir 83 and a deposit reservoir 84, and a discharging end 301 of the cation exchange unit 30 is in connection with an inlet segment 831 of the adjustment reservoir 83, such that polluted water produces in treatment of the cationic resin and discharges into the adjustment reservoir 83 for aeration treatment. An outlet segment 832 of the adjustment reservoir 83 is coupled with an inflow end 841 of the deposit reservoir 84, such that the polluted water after the aeration treatment is pumped into the deposit reservoir 84, and alkali sulfate is added into the deposit reservoir 84 to flocculate the polluted water and to produce the clean waters, wherein the clean waters flow into the RO concentration tank 60 from an outflow end 842 of the deposit reservoir 84, thus recycling the clean waters. In addition, deposited substances discharge into the filter press equipment 200 from the deposit reservoir 84.

The RO concentration tank 60 is mounted beside the cation exchange unit 30 and accommodates the waste waters stopped by said each first reverse osmosis set 41 and said each second reverse osmosis set 42, and the clean fluids are pumped into the RO concentration tank 60 so as to feed into the salt tank 82.

The evaporation unit 70 is MVPC evaporating equipment with low energy consumption and high operation efficiency and is configured between the RO concentration tank 60 and the recycling tank 50 so as to treat the waste waters in the distal end of the reverse osmosis treatment system. The evaporation unit 70 is configured to guide the sludge on a bottom of the RO concentration tank 60 and to evaporate original liquids by means of flash evaporation and a vapor compressor, hence the sludge is treated after condensate purification to remove volatilized substances and to produce distilled waters, and the distilled waters are guided into the recycling tank 50 for recycling and reusing purpose.

The crystallization unit 90 is disposed beside the evaporation unit 70 and treats evaporated liquids via a crystallizing chamber (not shown), a circulating pipe (not shown), and a circulating pump (not shown), and the waste waters flow back to the sequencing batch reactor 100 (SBR), wherein crystal slurry and solid residue after circulation discharge into the filter press equipment 200 for treatment.

Accordingly, after the SBR feeds waters into the first ultrafiltration unit 10 at 87 M³/h and the osmosis processing unit 40 treats the waste waters, recycled water produces at 4.2 M³/h, and the osmosis processing unit 40 discharges the waste waters at 2.8 M³/h, thereby producing the clean waters at 96% to obtain high recycling efficiency and to reduce the waste waters.

The recycling treatment system of the present invention contains advantages as follows:

1. The recycling treatment system comprises the first ultrafiltration unit 10 and the second ultrafiltration unit 20 which are configured to filter the waste waters, and the cation exchange unit 30 eliminates the minerals and the heavy metals (such as chromium or barium) to avoid the clog in the holes on the distal end of the reverse osmosis treatment system. Preferably, the first ultrafiltration unit 10 and the second ultrafiltration unit 20 backwash and scratch the sludge on the plural first and second ultrafiltration bags so as to maintain filtration of the plurality of ultrafiltration sets and the at least one rotary ultrafiltration assembly after a period of using time.

2. The plurality of ultrafiltration sets, the at least one rotary ultrafiltration assembly, and the reverse osmosis treatment reduce the moisture content of the sludge to enhance recycling rate of the waste waters and to lower energy consumption in evaporation and crystallization of the sludge, thus decreasing waste waters and treatment cost.

3. COD value and TDS value of the recycled water produced by treatment system of SBR are controlled less than 30 mg/L and 150 mg/L so as to comply with environmental standard and to acquire excellent water quality, and the recycling rate of the waste waters is over 90% to overcome instability of the water quality produced by the conventional SBR.

4. The filtered fluids stored in the recycling tank 50 are evaporated, crystalized, and guided back to the SBR, and the solid residue is recycled and treated by the filter press equipment 200, thus reducing discharge of the waste waters greatly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A recycling treatment system for tannery wastewater being fixed between a sequencing batch reactor (SBR) and filter press equipment, and the recycling treatment system comprising:
a first ultrafiltration unit including a filtering tank configured to store concentrated sludge from the sequencing batch reactor, and the first ultrafiltration unit also including a plurality of ultrafiltration sets, each ultrafiltration set depositing in the filtering tank and formed in a circular disc shape, said each ultrafiltration set having plural first ultrafiltration bags arranged therein, and said each ultrafiltration set also having a fluid tube configured to pump filtered fluids out of the filtering tank from the plural first ultrafiltration bags;
a second ultrafiltration unit including a concentration tank configured to store the sludge stopped by the first ultrafiltration unit, and the second ultrafiltration unit also including at least one rotary ultrafiltration assembly formed in a circular disk shape and rotating in the concentration tank by using a power source, the second ultrafiltration unit further including a backwash pipe configured to collect the filtered fluids flowing through the at least one rotary ultrafiltration assembly, and the backwash pipe being in connection with the concentration tank, the second ultrafiltration unit further including a discharge pipe mounted on a bottom of the concentration tank and communicating with the filter press equipment;
a cation exchange unit connected with one end of the fluid tube and including a reaction sink and cationic resin filled in the reaction sink;
an osmosis processing unit mounted beside the cation exchange unit and including plural first reverse osmosis sets and plural second reverse osmosis sets, wherein the filtered fluids are pumped by a plurality of pressure pumps and are filtered by the plural first reverse osmosis sets and the plural second reverse osmosis sets, thus recycling the filtered fluids;
a recycling tank configured to recycle recycled water;
a RO concentration tank mounted beside the osmosis processing unit and configured to accommodate waste waters stopped by said each first reverse osmosis set and said each second reverse osmosis set; and
an evaporation unit configured between the RO concentration tank and the recycling tank so as to guide the sludge on a bottom of the RO concentration tank and to treat the sludge after condensate purification, such that volatilized substances are removed and distilled waters produce, and the distilled waters are guided into the recycling tank for recycling and reusing purpose.

2. The recycling treatment system as claimed in claim 1 further comprising a backwash tank fixed between the first ultrafiltration unit and the second ultrafiltration unit and configured to store backwashing waters from the backwash pipe.

3. The recycling treatment system as claimed in claim 1, wherein the second ultrafiltration unit further includes a scratching module rotatably scratching the sludge in the concentration tank, a density of suspended solids is increased, and the backwashing waters backwash the first ultrafiltration unit.

4. The recycling treatment system as claimed in claim 1, wherein a salt tank fixed between the cation exchange unit and the RO concentration tank.

5. The recycling treatment system as claimed in claim 1 further comprising an adjustment reservoir and a deposit reservoir, wherein a discharging end of the cation exchange unit is in connection with an inlet segment of the adjustment reservoir, such that polluted water discharges into the adjustment reservoir for aeration treatment; and an outlet segment of the adjustment reservoir is coupled with an inflow end of the deposit reservoir, such that the polluted water after the aeration treatment is pumped into the deposit reservoir for flocculation, and an outflow end of the deposit reservoir is connected in the RO concentration tank.

6. The recycling treatment system as claimed in claim 1 further comprising a crystallization unit disposed beside the evaporation unit.

7. The recycling treatment system as claimed in claim 1 further comprising an accommodation tank disposed between the cation exchange unit and the reverse osmosis processing unit.

8. The recycling treatment system as claimed in claim 1 further comprising a recycling tank connected with the reverse osmosis processing unit.
